(19) United States
(12) Patent Application Publication
(10) Pub. No.: US 2025/0080745 A1
(43) Pub. Date: Mar. 6, 2025

(54) METHOD FOR VIDEO ENCODING, METHOD FOR VIDEO DECODING, AND RELATED PRODUCT

(71) Applicant: Cambricon Technologies Corporation Limited, Beijing (CN)

(72) Inventor: Yingchun YUAN, Beijing (CN)

(21) Appl. No.: 18/724,114

(22) PCT Filed: Dec. 29, 2022
(86) PCT No.: PCT/CN2022/143564

§ 371 Date: Jun. 25, 2024

(30) Foreign Application Priority Data
Dec. 31, 2021 (CN) 202111665212.8

(51) Int. Cl. H04N 19/136

(52) U.S. Cl. CPC H04N 19/136

(57) ABSTRACT

The present disclosure provides video encoding and decoding methods and related products, where the methods are included in a combined processing apparatus, and the combined processing apparatus further includes an interface apparatus and other processing apparatus. A computing apparatus interacts with other processing apparatus to jointly complete a computing operation specified by a user. The combined processing apparatus further includes a storage apparatus. The storage apparatus is connected to the apparatus and other processing apparatus, respectively. The storage apparatus is configured to store data of the apparatus and other processing apparatus. A technical scheme of the present disclosure may significantly improve video compression efficiency.

### CROSS REFERENCE OF RELATED APPLICATION

The present application is a 371 of International Application No. PCT/CN2022/143564, filed Dec. 29, 2022, which claims priority to Chinese Patent Application No. 202111665212.8 with the title of “Method for Video Encoding, Method for Video Decoding, and Related Product” filed on Dec. 31, 2021.

### TECHNICAL FIELD

The present disclosure relates to the field of video communication and, more specifically, to the field of video codec.

### BACKGROUND

With the development of artificial intelligence, multimedia video technology is used more and more widely, and the amount of video data that is required to be stored or transmitted is also increasing. In order to save storage or transmission costs, these pieces of video data are required to be compressed more efficiently.

A current video encoding standard mainly adopts a hybrid encoding framework of “prediction+transformation”. Such an encoding framework is mainly designed for general videos and does not perform adequate codec optimization for video application requirements for taking characters as the object of attention and actions of the characters as the focus of attention.

For example, in teaching videos for dance and sports movements, people are usually the main subject of the video. Viewers focus on changes in body movements and are not very sensitive to background and clothing. Existing encoding methods are required to be further improved in the encoding efficiency of such videos.

### SUMMARY

The purpose of the present disclosure is to provide video encoding and decoding methods that are capable of reducing data transmission and storage amounts.

A first aspect of the present disclosure provides a video encoding method, including: receiving a video sequence; identifying character elements in the video sequence; extracting character key point data from the identified character elements; fitting the extracted character key point data with a standard character model to obtain character fitting parameters; encoding the character key point data to form encoded character key point data; and encoding the character fitting parameters to form encoded character fitting parameters.

A second aspect of the present disclosure provides a video decoding method, including: receiving a structured information code stream, where the structured information code stream includes at least encoded character key point data and encoded character fitting parameters; decoding the encoded character fitting parameters to form a personalized character model; and decoding the encoded character key point data to form a character image of a corresponding frame.

A third aspect of the present disclosure provides a method for transmitting a video sequence, including: encoding the video sequence, including: receiving the video sequence; identifying character elements in the video sequence; extracting character key point data from the identified character elements; fitting the extracted character key point data with a standard character model to obtain character fitting parameters; encoding the character key point data to form encoded character key point data; encoding the character fitting parameters to form encoded character fitting parameters; forming a structured information code stream according to the encoded character key point data and the encoded character fitting parameters; and decoding the structured information code stream, including: receiving the structured information code stream, where the structured information code stream includes at least the encoded character key point data and the encoded character fitting parameters; decoding the encoded character fitting parameters to form a personalized character model; and decoding the encoded character key point data to form a character image of a corresponding frame.

A fourth aspect of the present disclosure provides an electronic device. The electronic device includes: one or a plurality of processors; and a memory, on which a computer-executable instruction is stored, where when the computer-executable instruction is run by the one or the plurality of processors, the electronic device performs the above-mentioned method.

A fifth aspect of the present disclosure provides a computer-readable storage medium, including a computer-executable instruction, where when the computer-executable instruction is run by one or a plurality of processors, the above-mentioned method is performed.

A technical scheme of the present disclosure may significantly improve video compression efficiency. In view of a video application scenario where characters are taken as the main subject and the object of attention, by extracting human body key points for action representation, and then describing elements, such as clothing, a skin color, and a body type, of a character through concise structured information, a large high-definition video may be compressed into a small code stream represented by key feature points and several corresponding groups of description information, which greatly saves storage and transmission costs.

### BRIEF DESCRIPTION OF DRAWINGS

By reading the following detailed description with reference to drawings, the above-mentioned and other objects, features and technical effects of exemplary implementations of the present disclosure will become easier to understand. In the drawings, several implementations of the present disclosure are shown in an exemplary manner rather than a restrictive manner, and the same or corresponding reference numerals indicate the same or corresponding parts.

FIG. 1 shows a schematic diagram of a neural network (NN).

FIG. 2a shows a flowchart of a video encoding method according to an embodiment of the present disclosure.

FIG. 2b shows an operation diagram of an encoder for video encoding according to an embodiment of the present disclosure.

FIG. 3 shows a method flowchart according to a preferred embodiment of the present disclosure.

FIG. 4 shows a schematic diagram of complementing a blocked area of a background based on a plurality of video frames.

FIG. 5a shows a video decoding method according to an embodiment of the present disclosure.

FIG. 5b shows a schematic diagram of a decoding operation in a decoder according to an implementation of the present disclosure.

FIG. 6 shows a method for transmitting a video sequence according to an embodiment of the present disclosure.

FIG. 7 shows a schematic diagram of a codec system of the present disclosure.

FIG. 8 shows a combined processing apparatus.

### DETAILED DESCRIPTION

Technical solutions in embodiments of the present disclosure will be described clearly and completely hereinafter with reference to drawings in the embodiments of the present disclosure. Obviously, embodiments to be described are merely some rather than all embodiments of the present disclosure. All other embodiments obtained by those skilled in the art based on the embodiments of the present disclosure without creative efforts shall fall within the scope of protection of the present disclosure.

It should be understood that terms such as “first”, “second”, “third”, and “fourth” that appear in the claims, the specification, and the drawings are used for distinguishing different objects rather than describing a specific order. “First”, “second”, “third”, and “fourth” do not just mean one, but may also mean multiple. It should be understood that terms “including” and “comprising” used in the specification and the claims indicate the presence of a feature, an entity, a step, an operation, an element, and/or a component, but do not exclude the existence or addition of one or more of other features, entities, steps, operations, elements, components, and/or collections thereof.

It should also be understood that the terms used in the specification of the present disclosure are merely intended to describe a specific embodiment rather than to limit the present disclosure. As being used in the specification and the claims of the present disclosure, unless the context clearly indicates otherwise, singular forms such as “a”, “an”, and “the” are intended to include plural forms. It should also be understood that a term “and/or” used in the specification and the claims refers to any and all possible combinations of one or more of relevant listed items and includes these combinations.

As being used in the specification and the claims of the present disclosure, a term “if” may be interpreted as “when”, or “once” or “in response to a determination” or “in response to a case where something is detected” depending on the context. Similarly, depending on the context, a clause “if it is determined that” or “if [a described condition or event] is detected” may be interpreted as “once it is determined that”, or “in response to a determination”, or “once [a described condition or event] is detected”, or “in response to a case where [a described condition or event] is detected”.

“Key point data” in face recognition and character action recognition is required to be explained first.

Key point data detection in face recognition is also known as face key point detection, positioning, or face alignment, which refers to locating key areas of a human face for a given facial image, including data about eyes, a nose bridge shape, a mouth shape, and a facial shape of the human face.

Key point data detection in character action recognition usually includes detection of human skeleton key point data. The human skeleton key point data may include, for example, detection of important joints, such as elbow, shoulder and knee joints. Through the connection of these parts, basic movements of a human body may be outlined more accurately.

A technical scheme of the disclosure, such as detection of key point data and detection of background elements, may all be implemented by machine learning, and machine learning may be implemented by neural network algorithms.

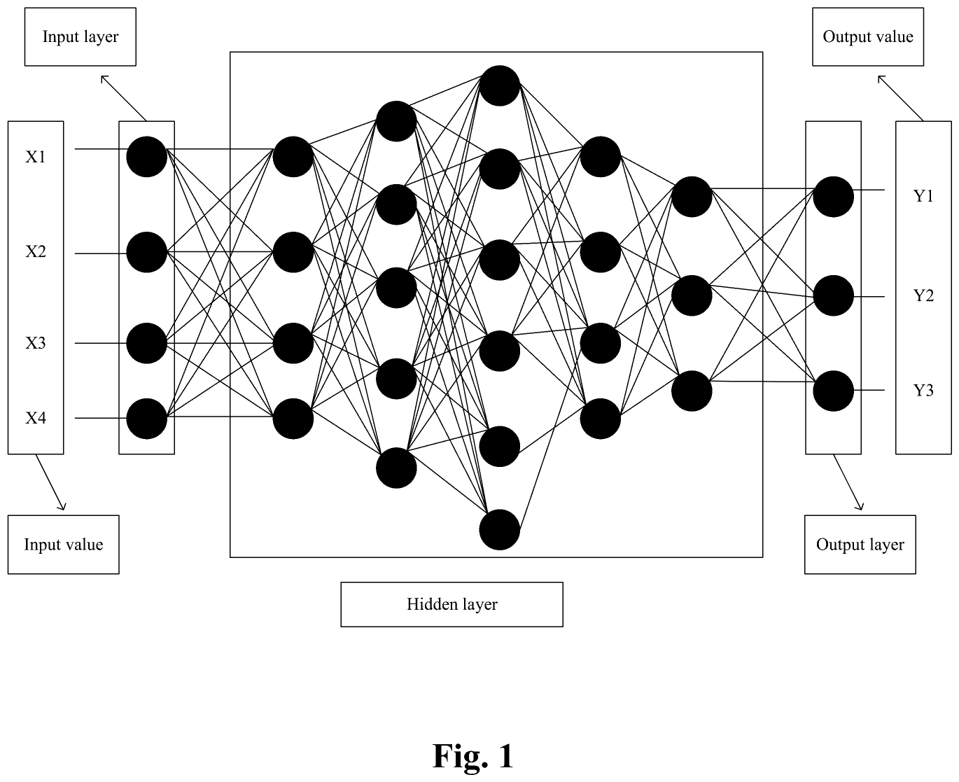

FIG. 1 shows a schematic diagram of a neural network (NN). The neural network is a mathematical model which imitates structures and functions of a biological neural network, and performs calculations through connecting a large number of neurons. Therefore, the neural network is a computing model composed of plenty of connected nodes (or called “neurons”). Each node represents a specific output function called an activation function. A connection between every two neurons represents a weighted value that passes through this connection signal, which is called a weight. The weight corresponds to a memory of the neural network. An output of the neural network varies according to different connections between neurons, different weights, and different activation functions. In the neural network, a neuron is a basic unit. The neuron acquires a certain number of inputs and a bias, which may be multiplied by a weight when a signal (value) arrives. The connection refers to connecting one neuron to another neuron in another layer or a same layer, and the connection is accompanied by an associated weight. In addition, the bias is an extra input of the neuron, which is always 1 and has its own connection weight. This ensures that the neuron may be activated even if all inputs are empty (all inputs are 0).

In applications, if no non-linear function is applied to the neuron in the neural network, the neural network is only a linear function and is not powerful than a single neuron. If an output result of the neural network is between 0 and 1, for example, in a case of cat and dog identification, an output close to 0 may be regarded as a cat, and an output close to 1 may be regarded as a dog. In order to accomplish this goal, an activation function, such as a sigmoid activation function, is introduced into the neural network. Regarding this activation function, a return value of the activation function is a number between 0 and 1. Therefore, the activation function is used to introduce non-linearity into the neural network, which may narrow an operation result of the neural network to a small range. In fact, how the activation function is represented is not important, and what is important is to parameterize a non-linear function by some weights, thus changing the non-linear function by changing the weights.

FIG. 1 is a schematic structural diagram of a neural network. The neural network shown in FIG. 1 contains three layers: an input layer, a hidden layer, and an output layer, respectively. The hidden layer shown in FIG. 1 contains five layers. A leftmost layer in the neural network is called the input layer, and a neuron in the input layer is called an input neuron. As a first layer in the neural network, the input layer receives input signals (values) and transmits the signals (values) to a next layer. The input layer generally does not perform operations on the input signals (values) and does not have associated weights or biases. The neural network shown in FIG. 1 contains four input signals: x1, x2, x3, and x4.

The hidden layer contains neurons (nodes). The neural network shown in FIG. 1 contains five hidden layers. A first hidden layer contains four neurons (nodes), a second hidden layer contains five neurons, a third hidden layer contains six neurons, a fourth hidden layer contains four neurons, and a fifth hidden layer contains three neurons. Finally, the hidden layers transmit operation values of the neurons to the output layer. In the neural network shown in FIG. 1, each of the neurons in the five hidden layers is fully connected; in other words, each neuron in each hidden layer is connected with each neuron in a next layer. It is required to be noted that some hidden layers in the neural network are not fully connected.

A rightmost layer of the neural network shown in FIG. 1 is called the output layer, and a neuron in the output layer is called an output neuron. The output layer receives an output from the last hidden layer. In the neural network shown in FIG. 1, the output layer contains three neurons and three output signals y1, y2, and y3.

In practical applications, plenty of sample data (including inputs and outputs) are given in advance to train an initial neural network. After training, a trained neural network is obtained. The trained neural network may give a right output for an input from a real environment in the future.

Before the discussion of neural network training, a loss function is required to be defined. The loss function is a function that measures the performance of the neural network in performing a particular task. In some embodiments, the loss function may be obtained in a following manner: transferring each piece of sample data along the neural network in the process of training a certain neural network to obtain an output value, performing subtraction between the output value and an expected value to obtain a difference, and then squaring the difference. The loss function obtained in the manner is the distance between the expected value and a true value. The purpose of training the neural network is to reduce the distance or the value of the loss function. In some embodiments, the loss function may be represented as:

$$L ( y , \hat{y} ) = \frac{1}{m} {\sum }_{i = 1}^{m} {( {y}_{i} - {\hat{y}}_{i} )}^{2}$$

In the formula, y represents an expected value, ŷ represents an actual result of each piece of sample data in a sample data set through a neural network, and i represents an index of each piece of sample data in the sample data set. L(y, ŷ) represents a difference between the expected value y and the actual result ŷ. m represents a count of sample data in the sample data set. Taking cat-dog identification as an example, there is a data set composed of pictures of cats and dogs. If a picture is of a dog, a corresponding label is 1, and if the picture is of a cat, a corresponding label is 0. The label corresponds to the expected value y in the above formula. The purpose of transmitting each sample picture to the neural network is to obtain a recognition result through the neural network. In order to compute the loss function, each sample picture in the sample data set is required to be traversed to obtain an actual result ŷ corresponding to each sample picture, and then the loss function is computed according to the above definition. If the value of the loss function is relatively large, it is shown that the neural network has not been trained well, and the weight is required to be further adjusted.

At the beginning of neural network training, the weight is required to be randomly initialized. Obviously, an initialized neural network may not provide a good result. In the training process, if the training is started with a bad neural network, through training, a network with high accuracy may be obtained.

The training process of the neural network includes two stages. A first stage is forward processing of a signal, which is from an input layer through a hidden layer, and finally to an output layer. A second stage is back propagation of a gradient, which is from the output layer to the hidden layer, and finally to the input layer, where a weight and a bias of each layer in the neural network are adjusted successively according to the gradient.

In the process of forward processing, an input value is input into the input layer in the neural network, and an output (a predicted value) is obtained from the output layer in the neural network. When the input value is input into the input layer in the neural network, the input layer does not perform any operation. In the hidden layers, the second hidden layer obtains a predicted intermediate result value from the first hidden layer to perform a computing operation and an activation operation, and then transmits the obtained predicted intermediate result value to a next hidden layer. The same operations are performed in the following layers to obtain the output value in the output layer in the neural network.

After the forward processing, the output value called the predicted value is obtained. In order to compute an error, the predicted value is compared with an actual output value to obtain a corresponding error. A chain rule of calculus is used in the back propagation. In the chain rule, derivatives of errors corresponding to weights of the last layer in the neural network are computed first. These derivatives are called gradients. Then, these gradients are used to compute gradients of a penultimate layer of the neural network. This process is repeated until a gradient corresponding to each weight in the neural network is obtained. Finally, a corresponding gradient is subtracted from each weight in the neural network to update the weight once, so as to achieve the purpose of reducing the error.

For the neural network, fine-tuning refers to loading a trained neural network. Like the process of training, the process of fine-tuning also includes two stages. The first stage is the forward processing of the signal, and the second stage is the back propagation of the gradient, thus updating the weight in the trained neural network. The difference between the training and the fine-tuning is that the training refers to randomly processing the initialized neural network and training the neural network from scratch, while the fine-tuning does not randomly process the initialized neural network and train the neural network from scratch.

In the process of training or fine-tuning the neural network, each time the neural network goes through the forward processing of the signal and the back propagation of the corresponding error once, the weights in the neural network are updated once by using the gradient, and the whole process is called an iteration. In order to acquire a neural network with expected precision, a very large sample data set is required in the training process. In this situation, it is impossible to input the whole sample data set into a computer at a time. Therefore, in order to solve this problem, the sample data set is required to be divided into a plurality of blocks, and each block of the sample data set is transmitted to the computer. After forward processing of each block of the sample data set, the weight of the neural network is updated once correspondingly. When the whole sample data set passes through the forward processing of the neural network once and the weight update is returned once correspondingly, this process is called an epoch. In practice, it is not enough to transmit the whole data set in the neural network once, and the whole data set is required to be transmitted in the same neural network multiple times. In other words, a plurality of epochs are required to finally obtain the neural network with the expected precision.

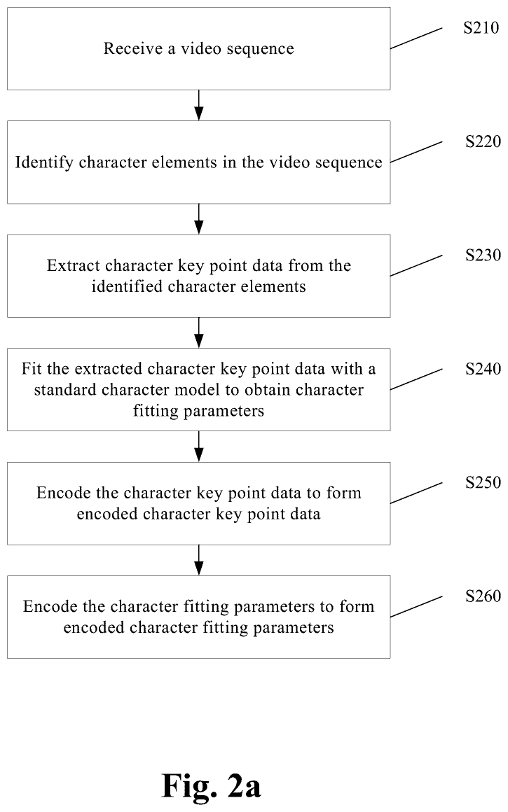

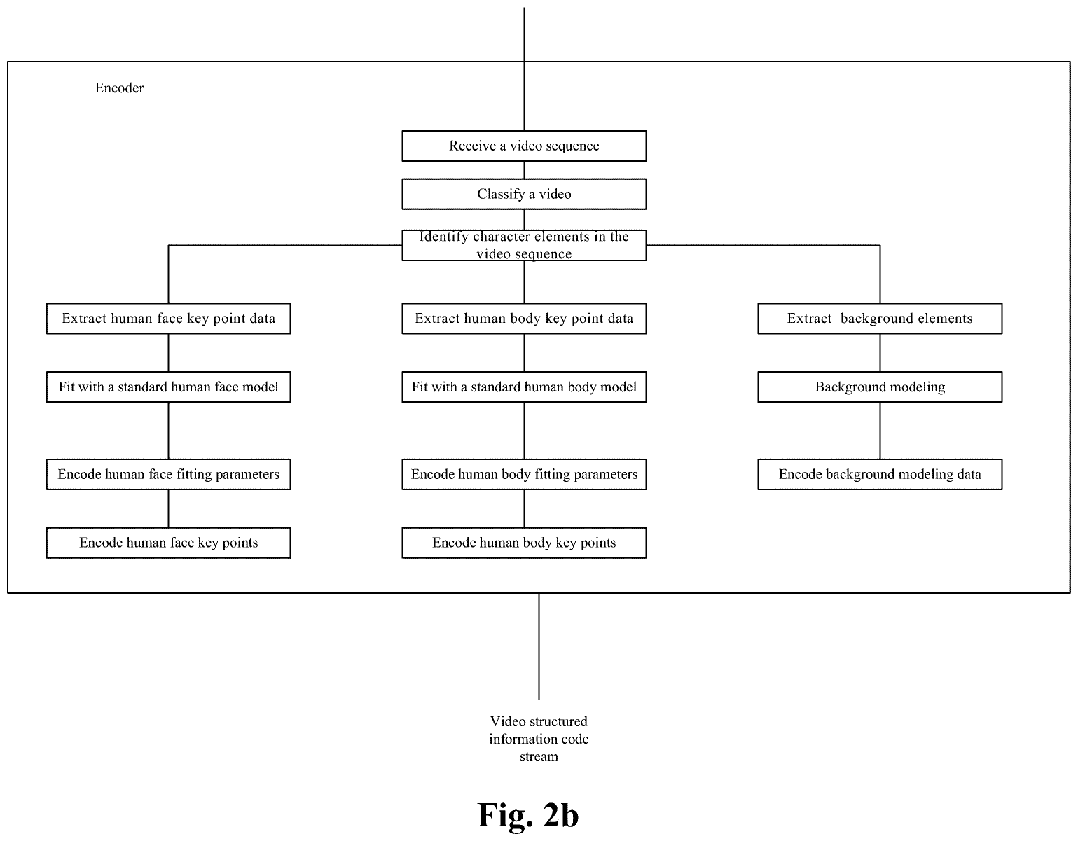

FIG. 2a shows a flowchart of a video encoding method according to an embodiment of the present disclosure. FIG. 2b shows an operation diagram of an encoder for video encoding according to an embodiment of the present disclosure. FIG. 2a and FIG. 2b correspond to each other, so in the following, the interpretation of FIG. 2a may also refer to FIG. 2b.

As shown in FIG. 2a, the method includes: operation S210, receiving a video sequence; operation S220, identifying character elements in the video sequence; operation S230, extracting character key point data from the identified character elements; operation S240, fitting the extracted character key point data with a standard character model to obtain character fitting parameters; operation S250, encoding the character key point data to form encoded character key point data; and operation S260, encoding the character fitting parameters to form encoded character fitting parameters.

As shown in FIG. 2a, the video sequence may be continuous multi-frame images in a video. Preferably, these video sequences include a character, and the character is taken as the main content. Such video sequences include but are not limited to a dance video sequence, a sports video sequence, a fitness teaching video sequence, and so on. A common feature of these video sequences is that the action of the character is abundant, and background content is monotonous. For example, in football, there are many changes in the movements of players on the field, such as running, shooting, defending, and tackling, while the background is mainly the field and the audience, which is relatively monotonous. For most of these videos, even if the background is changed, there is no effect on the video viewer. Or, for some video streams, even if the background looks more complex, such as a dense crowd of fans in a soccer stand, the video viewer is not particularly concerned about these backgrounds, and for the same game, even if the fans in the background are replaced, most video viewers may still not notice such a change.

After the video sequence is received, and before the character elements are identified, the content of the video sequence may also be classified through machine learning to determine whether the video sequence contains character elements of concern. For example, if the video sequences only include scenery, cars, animals, and other content without the character elements of concern, these video sequences are not the video sequences to be considered in the technical scheme of the present disclosure. This step is optional and is not shown in the operation steps of FIG. 1.

For the operation S220, the character elements of concern may be identified from the video sequence. It is required to be understood that the “character elements” referred to in the present disclosure mainly refer to prominent character elements in the video stream, such as the players on the football field and the fitness coach in the fitness program. Although the audience on the field also belongs to the character elements, because the distinction between the audience on the field is very small, the audience on the field may be used as a background element in the video stream. Identifying the character elements may be selecting the characters of concern from the video stream and then locating the characters of concern.

After the character elements of concern are identified, the character key point data of the character elements may be extracted. The character key point data may include human body key point data and human face key point data. However, for different videos, important character key point data may be different.

For example, for some videos that pay more attention to character facial expressions, such as a crosstalk program, a host program, and a talk show, the character facial expressions are more attractive than character body movements, so the character key point data in these videos mainly includes the human face key point data. For some video programs with obvious body movements, such as a fitness program and an acrobatic program, the movements are more attractive, so the character key point data in these videos mainly includes the human body key point data. For some video programs where movements and expressions are equally important, such as a dance program and a basketball game program, the movements and the expressions are equally important, so the character key point data in these videos mainly includes the human body key point data and the human face key point data.

As mentioned above, the human body key point data may include the human skeleton key point data, and the human face key point data may include the data about the eyes, the nose bridge shape, and the mouth shape of the human face. Through the key point data, the character may be expressed and restored more easily, and by representing the character using the key point data, the amount of data transmission may be reduced significantly, thereby improving data transmission efficiency.

Next, the extracted character key point data may be fitted with the standard character model, for example, through machine learning. The standard character model refers to a virtual character model. The virtual character model may be a computer-generated virtual character image, such as a cartoon image or a virtual real person image, and the virtual character model may also be an electronic image (such as an electronic photo, a video screenshot, and the like) of a real person. For example, a full-length photo of a soccer star may be chosen as the virtual character model. The standard character model may be either a 3D model or a 2D model. The 3D model has more abundant data and is more realistic than the 2D model.

When the extracted character key point data is fitted with the standard character model, the key point data extracted from the video sequence may be matched or fitted with the standard character model by stretching, twisting, and other ways, so that the fitted parameters or parameter sets may be obtained.

According to an embodiment of the present disclosure, fitting the extracted character key point data with the standard character model to obtain the character fitting parameters may include: fitting the human body key point data with a standard human body model to obtain human body fitting parameters; and/or fitting the human face key point data with a standard human face model to obtain human face fitting parameters.

The human body fitting parameters and the human face fitting parameters are deviations of a to-be-encoded character from a standard model. The fitting parameters depend on a modeling method of the standard model of the character, which includes triangular surface, grid, and so on. For example, if the 3D model or 2D model is used as a grid model, a to-be-encoded character in a picture may be divided in the same grid form, then the to-be-encoded character is aligned (registration) to the standard model (for example, registration is performed with a head as a center point), and then, based on a certain scaling ratio, three-dimensional or two-dimensional coordinate deviation values between vertices of the grid of the to-be-encoded character and vertices of the grid of the standard model are the fitting parameters. The number of parameters depends on the thickness of the grid division. In the process of decoding, a personalized model of the character may be obtained according to the standard model and the deviation values.

The character key point data is generally less, which is only used to represent a facial state or body movements of a character in a current frame. The fitting parameter is a set of points with a large amount of data. In theory, a to-be-encoded character standing expressionlessly may be obtained according to the fitting parameter and the standard model. By adjusting facial features of the character through human face key points, a specific expression may be obtained, and by adjusting the position and deformation of limbs of the character through human body key points, a specific action may be obtained.

Therefore, through the above process, the character key point data including the human body key point data and the human face key point data may be obtained, and the character fitting parameters including the human body fitting parameters and the human face fitting parameters may be obtained. The above combination of the human body key point data and the human body fitting parameters may show various actions of the character in the video, such as jumping, running, dancing, and flipping, while the above combination of the human face key point data and the human face fitting parameters may show facial features and emotional changes of the character, such as angriness, gladness, worriment, and so on. Compared with the complete transmission of the video sequence, the transmission of only the character key point data and the character fitting parameters may greatly reduce the amount of data required in the transmission.

It is required to be noted that the character fitting parameters rely on multi-frame image data. Because through as many image frames as possible, it is possible to grasp human body and face data of a current to-be-encoded character more comprehensively. A set of fitting parameters may be obtained through a multi-frame to-be-encoded image and a standard model of a character (which is usually a model in the attention pose with a serious expression). However, the transmission of the whole video sequence only needs to transmit a set of character fitting parameters, which greatly reduces the amount of data transmission.

In order to more accurately represent the facial expression of the character, such as whether the eyes are squinted, whether the eyebrows are wrinkled, and whether the mouth is raised or drooped, the character key points, such as the human face key points, are required to be encoded in every frame. These key points may represent the deformation and displacement of the five sense organs more accurately, making the character image more abundant and full. At the same time, compared with the fitting points, the amount of data representing the deformation and displacement of the five sense organs is much smaller, which has no significant impact on the data transmission and storage.

Further, in order to facilitate transmission, the character key point data may be encoded, including: encoding the human body key point data; and encoding the human face key point data.

The character fitting parameters may be encoded to form the encoded character fitting parameters, including: encoding the human body fitting parameters; and encoding the human face fitting parameters.

Any existing encoding method suitable for communication may be used to encode the character key point data and the character fitting parameters, so as to facilitate the transmission of these pieces of data by video. The encoding method may be composite encoding, including image compression of basic image data of a key frame and entropy encoding of the extracted structured data and model fitting parameters. The structured data includes key feature points of the face and body, character feature description data (such as data about height and weight, costume and skin color, hair style, hair color, skin details (such as pore feature), and lighting mode), and background feature description data (such as data about white wall, grass, carpet, and the like).

Optionally, differential encoding may be used in the process of encoding; in other words, an offset (MVD) of each frame relative to a key frame (I frame) may be computed. Such differential encoding may further reduce the amount of encoding information.

It is required to be understood that in some application scenarios, the background is not necessary. For example, for a fitness teaching video, the background is always very monotonous and almost unchanged, and video viewers may clearly distinguish movements of fitness teaching in the video even without the background. When there is no background, any desired background may be added to the video later, so that video stitching and editing may also be applied.

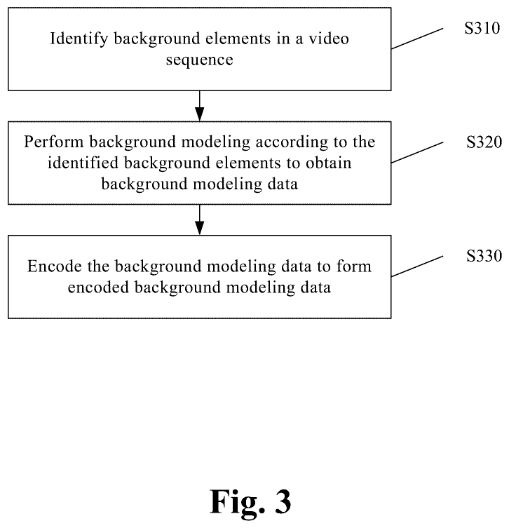

FIG. 3 shows a method flowchart according to a preferred embodiment of the present disclosure. As shown in FIG. 3, preferably, the method of the present disclosure further includes: operation S310, identifying background elements in a video sequence; operation S320, performing background modeling according to the identified background elements to obtain background modeling data; and operation S330, encoding the background modeling data to form encoded background modeling data.

The background elements in the video sequence may be identified using machine learning. The segmented background may be further analyzed to extract key features and characterization elements in the background. For example, in a football game video, the background is mainly composed of lawn, goal, and field line. After the background elements are identified, modeling may be performed based on the identified background elements. The modeling requires only the retention of key data in the background elements. For example, for the football game video, the modeling of the lawn only needs to use some key descriptive parameters, such as the color and size of the lawn, the position of the goal in the lawn, the position of the field line, and the position of the advertising board relative to the lawn. With these descriptive parameters, the background may be well restored. Although there are some differences between the restored background and a real background, this kind of difference is not easy to detect for video viewers. This modeling method requires a small amount of data, thus saving the bandwidth required during data transmission.

After the background modeling data is obtained, the background modeling data may also be encoded. The encoding scheme has been explained above and will not be repeated here.

According to an embodiment of the present disclosure, performing the background modeling according to the identified background elements to obtain the background modeling data includes: complementing a blocked area of the background based on a plurality of video frames.

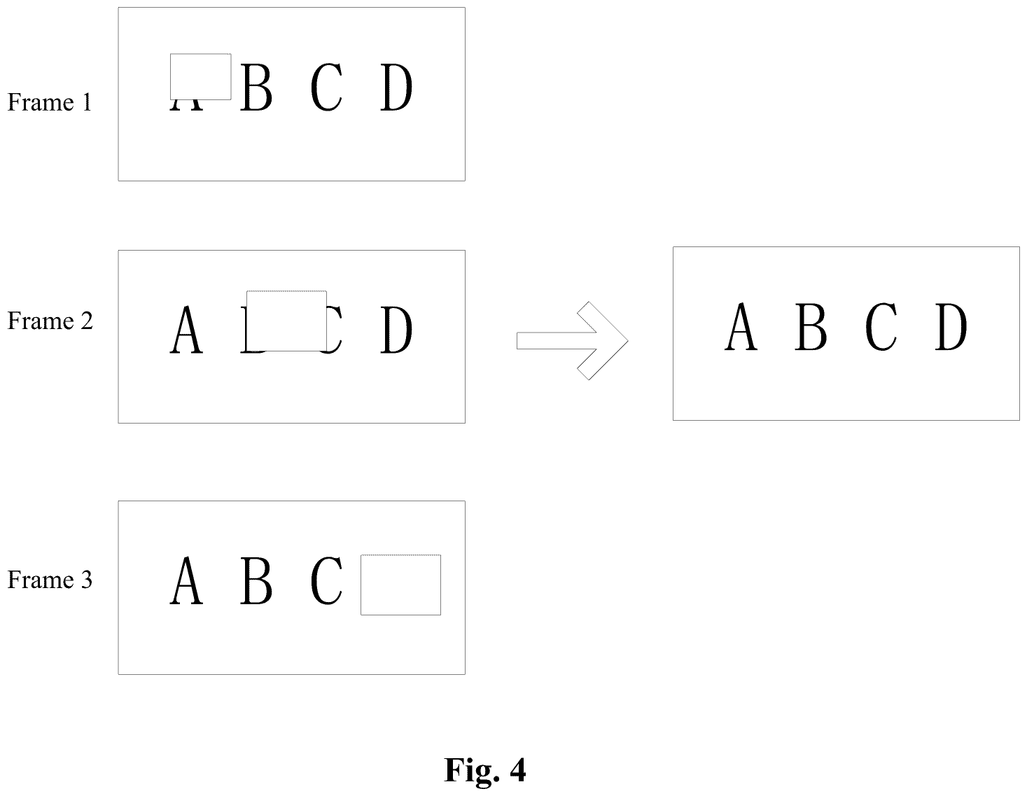

FIG. 4 shows a schematic diagram of complementing a blocked area of a background based on a plurality of video frames.

As shown in FIG. 4, some letters are blocked in the background, where a first letter in a frame 1 is partly blocked, but second, third, and fourth letters are clearly exposed; second and third letters in a frame 2 are partly blocked, but first and fourth letters are clearly exposed; and a fourth letter in a frame 3 is completely obscured, but first, second, and third letters are clearly exposed. Specific content of the blocked part may not be clearly distinguished in each frame, but actual content of the blocked part may be recovered based on information in a plurality of frames. Therefore, according to an embodiment of the present disclosure, the blocked part of the background may be complemented based on information of a plurality of frames, thus fully modeling the background part.

As can be seen from the above description, in some embodiments, there is no need to model the background, so that only the encoded character key point data and the encoded character fitting parameters are obtained, and then the structured information code stream is formed according to the encoded character key point data and the encoded character fitting parameters.

In other embodiments, the background is required to be modeled, so that the structured information code stream is formed according to the encoded character key point data, the encoded character fitting parameters, and the encoded background modeling data.

The structured information code stream is a highly organized and neatly formatted data code stream that may be easily searched by a computer. The structured data code stream, also known as a quantitative data code stream, is information that may be represented by data or a uniform structure, such as a number or a symbol, which may be easily searched by a computer program. The explicit relationships of the structured information code stream make these pieces of code stream data very convenient to use.

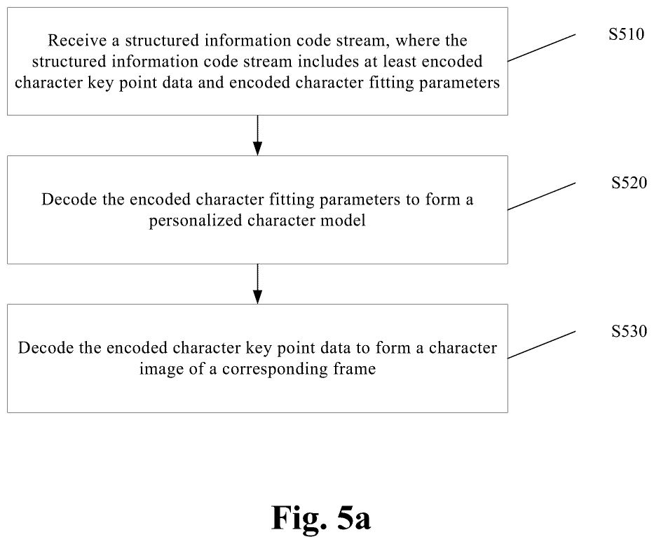

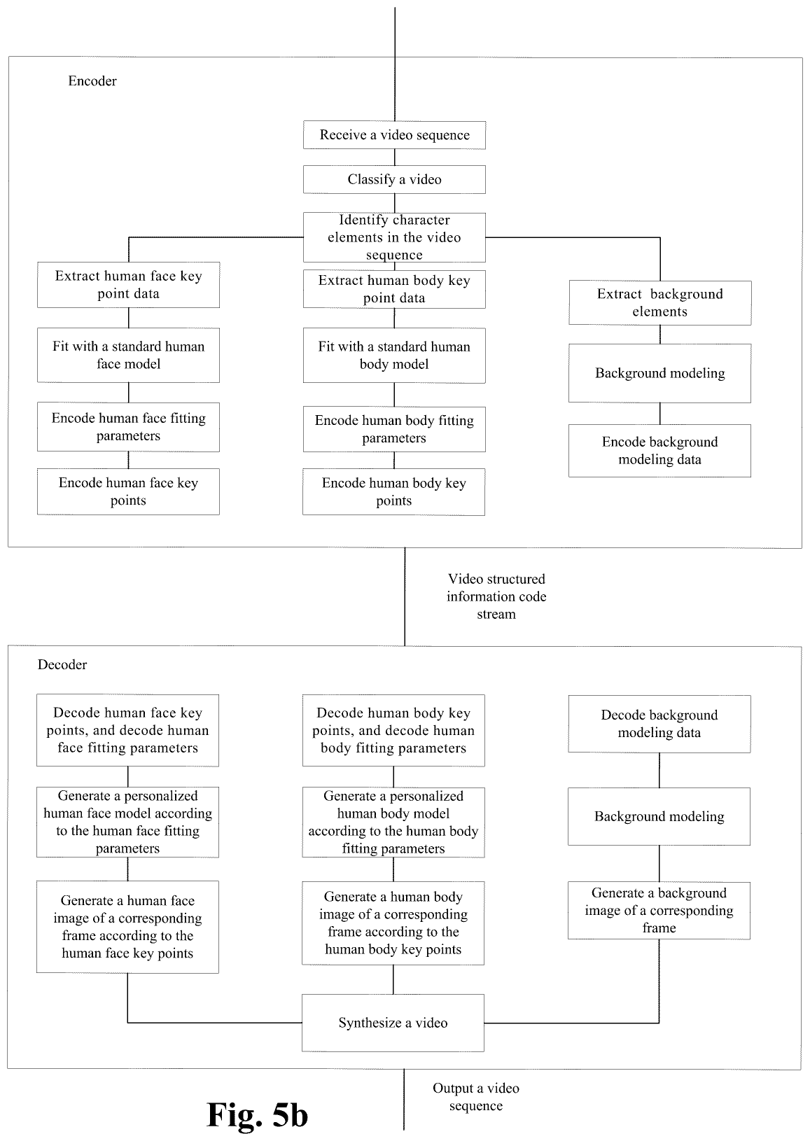

FIG. 5a shows a video decoding method according to an embodiment of the present disclosure. FIG. 5b shows a schematic diagram of a decoding operation in a decoder according to an implementation of the present disclosure. It is required to be understood that for ease of understanding, FIG. 5b also includes the encoding part of FIG. 2b, FIG. 5b and FIG. 5a form a corresponding relationship, and the interpretation of FIG. 5a is also applicable to FIG. 5b.

As shown in FIG. 5a, the video decoding method of the present disclosure includes: in an operation S510, receiving a structured information code stream, where the structured information code stream includes at least encoded character key point data and encoded character fitting parameters; in an operation S520, decoding the encoded character fitting parameters to form a personalized character model; and in an operation S530, decoding the encoded character key point data to form a character image of a corresponding frame.

At the decoder side, as shown in FIG. 5b, the structured information code stream described above may be received from the encoder side, and the structured information code stream may include the encoded character key point data, or the encoded character fitting parameters, or both. Preferably, the structured information code stream may also include encoded background modeling data, which will be described below.

Further, the personalized character model may be obtained by decoding the encoded character fitting parameters in the structured information code stream. The personalized character model is a model adjusted by specific character key point data on the basis of a standard character model. For example, if the standard character model is an image of a famous actor, then the personalized character model adjusted by the specific character key point data shows dual characteristics of this famous actor and this specific character image; in other words, from the perspective of ordinary people, the personalized character model resembles both the famous actor and the specific character. Of course, if the standard character model is a cartoon character, then the cartoon character partly represents the specific character image. This has a good application prospect for animation, film and television production.

Further, the encoded character key point data may also be decoded to form the character image of the corresponding frame. Since actions and expressions of the character in each frame of the video sequence may be different, specific features of the character in each frame may be restored by decoding the character key point data. When these features are combined with the above personalized character model, it is possible to make the personalized character model show corresponding expressions, actions, and so on, in each frame.

According to an embodiment of the present disclosure, the encoded character fitting parameters include encoded human body fitting parameters and encoded human face fitting parameters; decoding the encoded character fitting parameters to form the personalized character model includes: decoding the encoded human body fitting parameters to form a personalized human body model, and decoding the encoded human face fitting parameters to form a personalized human face model; the encoded character key point data includes encoded human body key point data and encoded human face key point data; and decoding the encoded character key point data to form the character image of the corresponding frame includes: decoding the encoded human body key point data to form a human body image of the corresponding frame, and decoding the encoded human face key point data to form a human face image of the corresponding frame.

At the decoder side, as shown in FIG. 5b, decoding more details will help make a final character representation more abundant and more vivid. The decoding of the human face fitting parameters and the human face key point data makes the expressions of the character more abundant, rather than just a blunt face. Meanwhile, using an image favored by a user as the standard human face model also helps to enhance the attention and love of the user for the video. The decoding of the human body fitting parameters and the human body key point data makes the actions of the character more abundant.

According to an embodiment of the present disclosure, the structured information code stream further includes the encoded background modeling data, and the method further includes: decoding the encoded background modeling data to generate the background modeling data; and generating the background image of the corresponding frame according to the background modeling data.

According to this embodiment, when the corresponding encoded background modeling data exists in the structured information code stream, the encoded background modeling data may be decoded, so that the background modeling data may be recovered.

According to an embodiment of the present disclosure, the method of the present disclosure further includes: synthesizing a video based on the personalized character model, the character image of the corresponding frame, and the background image of the corresponding frame. In this embodiment, when the recovered personalized character model, character image, and background image are synthesized together, a video stream that may be played may be obtained. In the synthesized video stream, because human face data and human body movement data of a character in an original video are retained, and the effect of the original video may be shown more accurately, but information code streams transmitted between the encoder and the decoder are structured representations, so data transmission amount will be small. In addition, since background information is optional, users, especially video producers, may have more flexible options. For example, the users may port videos to different backgrounds.

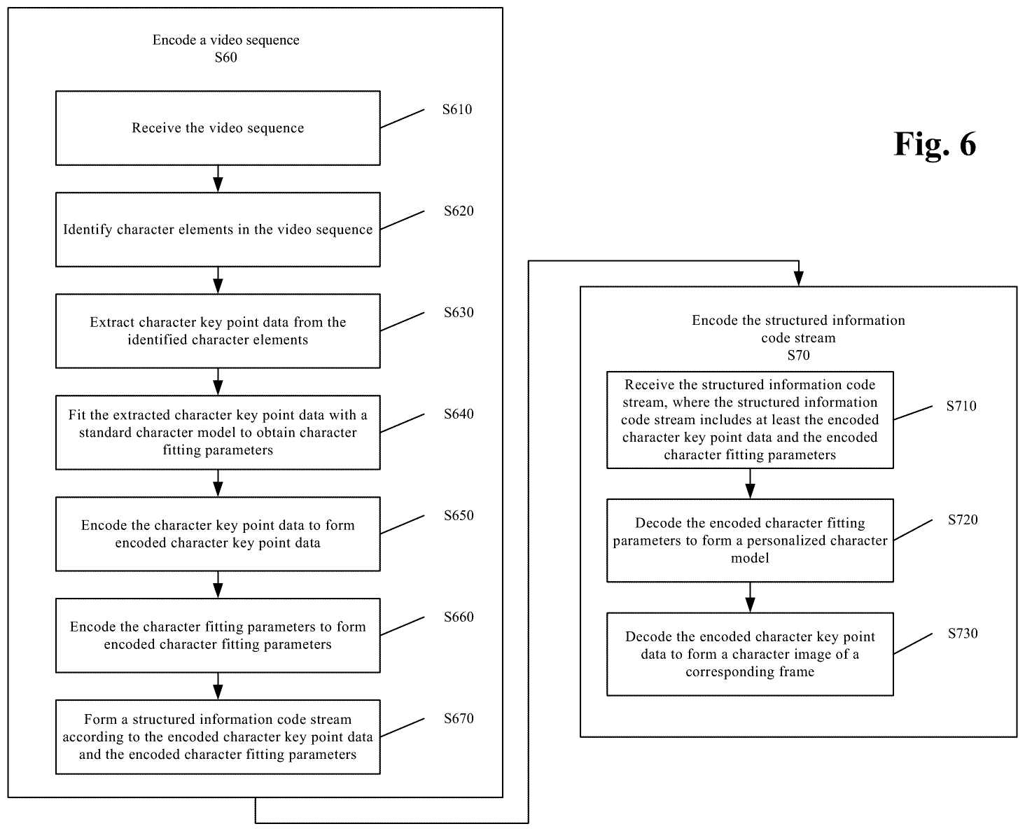

FIG. 6 shows a method for transmitting a video sequence according to an embodiment of the present disclosure, including: in an operation S60, encoding the video sequence, including: in an operation S610, receiving the video sequence; in an operation S620, identifying character elements in the video sequence; in an operation S630, extracting character key point data from the identified character elements; in an operation S640, fitting the extracted character key point data with a standard character model to obtain character fitting parameters; in an operation S650, encoding the character key point data to form encoded character key point data; in an operation S660, encoding the character fitting parameters to form encoded character fitting parameters; and in an operation S670, forming a structured information code stream according to the encoded character key point data and the encoded character fitting parameters; and in an operation S70, decoding the structured information code stream, including: in an operation S710, receiving the structured information code stream, where the structured information code stream includes at least the encoded character key point data and the encoded character fitting parameters; in an operation S720, decoding the encoded character fitting parameters to form a personalized character model; and in an operation S730, decoding the encoded character key point data to form a character image of a corresponding frame.

Operation steps in FIG. 6 have been described in detail in conjunction with FIGS. 1-5b above and will not be repeated here.

The present disclosure also provides an electronic device. The electronic device includes: one or a plurality of processors; and a memory, on which a computer-executable instruction is stored, where when the computer-executable instruction is run by the one or the plurality of processors, the electronic device performs the method described above.

The present disclosure also provides a computer-readable storage medium, including a computer-executable instruction, where when the computer-executable instruction is run by one or a plurality of processors, the method described above is performed.

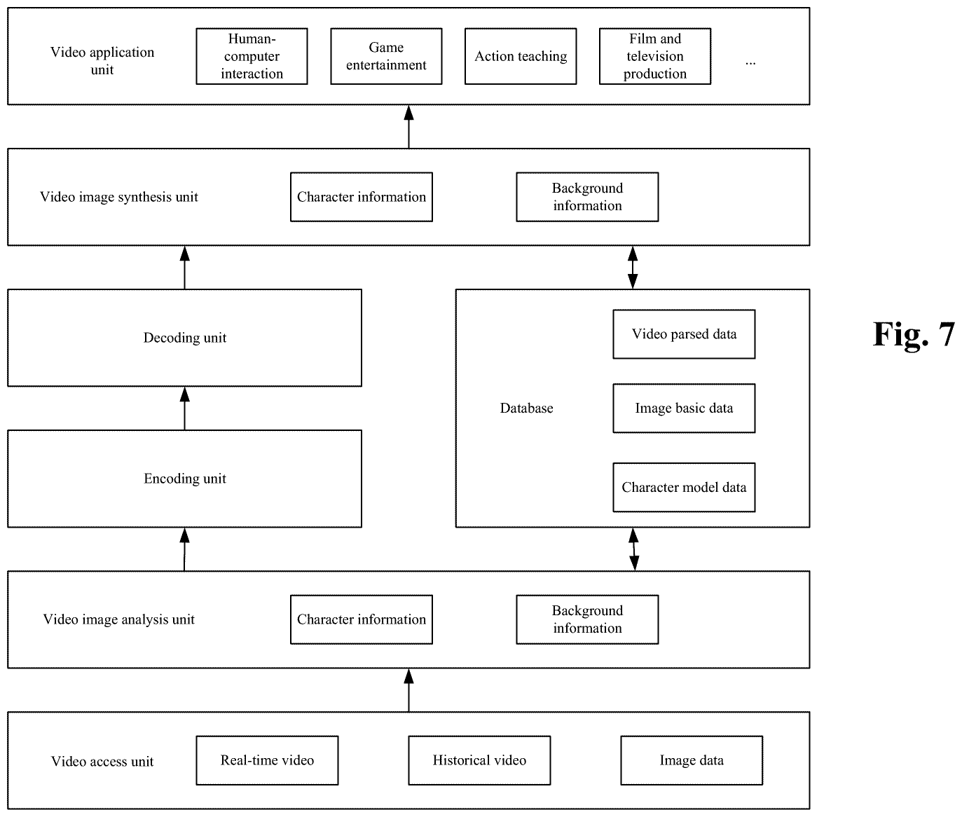

FIG. 7 shows a schematic diagram of a codec system of the present disclosure.

As shown in FIG. 7, the system includes a video access unit, which may receive a real-time video, a historical video, or image data. It is required to be understood that the video sequence described above may process single or multiple pictures essentially.

The system further includes a video image analysis unit, which is configured to parse character information and/or background information from the received real-time video, historical video, or image data.

The system further includes a database, on which character model data, image basic data, and various information obtained by parsing, such as task information and/or background information, may be stored.

The system further includes an encoding unit, which is configured to encode the task information and/or background information obtained by parsing, and a decoding unit, which is configured to decode the encoded data and information accordingly. The encoding and decoding processes have already been described in conjunction with FIGS. 1-6 above and will not be repeated here.

The system further includes a video image synthesis unit, which is configured to synthesize final character information and background information according to the information and data obtained by decoding and concatenate the character information and background information into a video.

This video further includes a video application unit. The obtained character information and background information may be used for human-computer interaction (such as virtual reality applications), game entertainment, action teaching, video production, and so on.

A technical scheme of the present disclosure may significantly improve video compression efficiency. In view of a video application scenario where characters are taken as the main subject and the object of attention, by extracting human body key points for action representation, and then describing elements, such as clothing, a skin color, and a body type, of a character through concise structured information, a large high-definition video may be compressed into a small code stream represented by key feature points and several corresponding groups of description information, which greatly saves storage and transmission costs.

The technical scheme of the present disclosure may be applied to the field of artificial intelligence and may be implemented as or may be implemented in an artificial intelligence chip. The chip may stand alone or may be included in a computing apparatus.

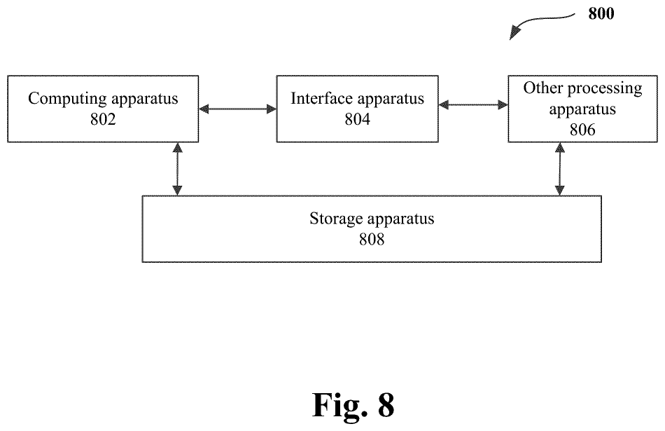

FIG. 8 shows a combined processing apparatus 800, including the above computing apparatus 802, an interface apparatus 804, and other processing apparatus 806. According to the present disclosure, the computing apparatus interacts with other processing apparatus to jointly complete an operation specified by a user. FIG. 8 is a schematic diagram of the combined processing apparatus.

Other processing apparatus includes one or more types of general-purpose/special-purpose processors, such as a central processing unit (CPU), a graphics processing unit (GPU), a neural network processor, and the like. A count of processors included in other processing apparatus is not limited. Other processing apparatus serves as an interface between a machine learning operation apparatus and external data and control, and completes basic controls, such as moving data, starting and stopping the machine learning operation apparatus; and other processing apparatus may also cooperate with the machine learning operation apparatus to jointly complete an operation task.

The interface apparatus is configured to transfer data and a control instruction between the computing apparatus (including, for example, the machine learning operation apparatus) and other processing apparatus. The computing apparatus acquires required input data from other processing apparatus and writes the data in an on-chip storage apparatus of the computing apparatus. The computing apparatus may also acquire control instructions from other processing apparatus and write the control instructions in an on-chip control cache of the computing apparatus. Additionally, the computing apparatus may further read data stored in the storage unit of the computing apparatus and transfer the data to other processing apparatus.

Optionally, this structure may further include a storage apparatus 808. The storage apparatus is connected to the computing apparatus and other processing apparatus, respectively. The storage apparatus is configured to store data of the computing apparatus and other processing apparatus. The storage apparatus is especially suitable for storing data that may not be completely stored in the internal storage of the computing apparatus or other processing apparatus of the present disclosure.

In several embodiments provided in the present disclosure, it should be understood that the apparatus disclosed may be implemented in other ways. For example, the apparatus embodiments described above are merely illustrative. For example, a division of units is only a logical function division. In an actual implementation, there may be other division methods. For example, a plurality of units or components may be combined or may be integrated in another system, or some features may be ignored or may not be performed. In addition, the displayed or discussed mutual coupling or direct coupling or communication connection may be implemented through indirect coupling or communication connection of some interfaces, apparatuses, or units, and may be in electrical, optical, acoustic, magnetic, or other forms.

Units described as separate components may or may not be physically separated. Components shown as units may or may not be physical units. In other words, the components may be located in one place or distributed to a plurality of network units. According to actual requirements, some or all of the units may be selected for achieving purposes of the embodiments of the present disclosure.

Additionally, each functional unit in each embodiment of the present disclosure may be integrated in one processing unit, or each unit may exist separately and physically, or two or more units may be integrated in one unit. The integrated unit described above may be implemented either in the form of hardware or in the form of a software program unit.

If the integrated unit is implemented in the form of the software program unit and sold or used as an independent product, the integrated unit may be stored in a computer-readable memory. Based on such understanding, when the technical scheme of the present disclosure is embodied in the form of a software product, the software product may be stored in a memory. The software product includes several instructions used to enable a computer device (which may be a personal computer, a server, or a network device, and the like) to perform all or part of steps of the method of the embodiments of the present disclosure. The foregoing memory includes: a USB flash drive, a read-only memory (ROM), a random access memory (RAM), a mobile hard disk, a magnetic disk, or an optical disc, and other media that may store program codes.

The embodiments of the present disclosure have been described in detail above. The present disclosure explains principles and implementations of the present disclosure with specific examples. Descriptions of the embodiments above are only used to facilitate understanding of the method and core ideas of the present disclosure. Simultaneously, those skilled in the art may change the specific implementations and application scope of the present disclosure based on the ideas of the present disclosure. In summary, the content of this specification should not be construed as a limitation on the present disclosure.

What is claimed:

1. A video encoding method, comprising:
receiving a video sequence;
identifying character elements in the video sequence;
extracting character key point data from the identified character elements;
fitting the extracted character key point data with a standard character model to obtain character fitting parameters;
encoding the character key point data to form encoded character key point data; and
encoding the character fitting parameters to form encoded character fitting parameters.

2. The method of claim 1, wherein the character key point data comprises human body key point data and human face key point data.

3. The method of claim 2, wherein
the human body key point data comprises human skeleton key point data; and
the human face key point data comprises data about eyes, a nose bridge shape, and a mouth shape of a human face.

4. The method of claim 2, wherein fitting the extracted character key point data with the standard character model to obtain the character fitting parameters comprises:
fitting the human body key point data with a standard human body model to obtain human body fitting parameters; and/or
fitting the human face key point data with a standard human face model to obtain human face fitting parameters.

5. The method of claim 2, wherein encoding the character key point data to form the encoded character key point data comprises:
encoding the human body key point data; and
encoding the human face key point data.

6. The method of claim 1, wherein encoding the character fitting parameters to form the encoded character fitting parameters comprises:
encoding the human body fitting parameters; and
encoding the human face fitting parameters.

7. The method of claim 1, further comprising:
identifying background elements in the video sequence;
performing background modeling according to the identified background elements to obtain background modeling data; and
encoding the background modeling data to form encoded background modeling data.

8. The method of claim 7, wherein performing the background modeling according to the identified background elements to obtain the background modeling data comprises: complementing a blocked area of a background based on a plurality of video frames.

9. The method of claim 1, further comprising: forming a structured information code stream according to the encoded character key point data and the encoded character fitting parameters.

10. The method of claim 7, further comprising:
forming a structured information code stream according to the encoded character key point data, the encoded character fitting parameters, and the encoded background modeling data.

11. A video decoding method, comprising:
receiving a structured information code stream, wherein the structured information code stream comprises at least encoded character key point data and encoded character fitting parameters.
decoding the encoded character fitting parameters to form a personalized character model; and
decoding the encoded character key point data to form a character image of a corresponding frame.

12. The method of claim 11, wherein
the encoded character fitting parameters comprise encoded human body fitting parameters and encoded human face fitting parameters; decoding the encoded character fitting parameters to form the personalized character model comprises:
decoding the encoded human body fitting parameters to form a personalized human body model; and
decoding the encoded human face fitting parameters to form a personalized human face model;
the encoded character key point data comprises encoded human body key point data and encoded human face key point data; decoding the encoded character key point data to form the character image of the corresponding frame comprises:
decoding the encoded human body key point data to form a human body image of the corresponding frame; and
decoding the encoded human face key point data to form a human face image of the corresponding frame.

13. The method of claim 11, wherein the structured information code stream further comprises encoded background modeling data, and the method further comprises:
decoding the encoded background modeling data to generate background modeling data; and
generating a background image of the corresponding frame according to the background modeling data.

14. The method of claim 13, further comprising:
synthesizing a video according to the personalized character model, the character image of the corresponding frame, and the background image of the corresponding frame.

15. A method for transmitting a video sequence, comprising:
encoding the video sequence, comprising:
receiving the video sequence;
identifying character elements in the video sequence;
extracting character key point data from the identified character elements;
fitting the extracted character key point data with a standard character model to obtain character fitting parameters;
encoding the character key point data to form encoded character key point data;
encoding the character fitting parameters to form encoded character fitting parameters; and
forming a structured information code stream according to the encoded character key point data and the encoded character fitting parameters; and
decoding the structured information code stream, comprising:
receiving the structured information code stream, wherein the structured information code stream comprises at least the encoded character key point data and the encoded character fitting parameters.
decoding the encoded character fitting parameters to form a personalized character model; and
decoding the encoded character key point data to form a character image of a corresponding frame.

16. (canceled)

17. (canceled)
